(19) United States
(12) Patent Application Publication
(10) Pub. No.: US 2011/0302918 A1
(43) Pub. Date: Dec. 15, 2011

(54) Motor vehicle and method for operating a combustion engine

(75) Inventors: Hubert Vollmer, Sao Paulo (BR); Jörg Riegner, Strahwald (DE); Thomas Hentschel, Ludwigsburg (DE); Dirk Schlösser, Heilbronn (DE)

(73) Assignee: Audi AG, Ingolstadt (DE)

(21) Appl. No.: 13/156,946

(22) Filed: Jun. 9, 2011

(30) Foreign Application Priority Data
Jun. 11, 2010 (DE) 10 2010 023 524.5

(51) Int. Cl. F02M 25/07; F02B 37/00

(52) U.S. Cl. 60/605.2; 60/605.1

(57) ABSTRACT

The invention relates to a motor vehicle with a combustion engine (10), from which exhaust gas is conducted to a turbine (16) of an exhaust-gas turbocharger (18), wherein exhaust gas can be diverted in flow direction of the exhaust gas upstream and downstream of the turbine (16) at respective withdrawal points (30, 32) and routed via a respective pipe system (34, 36) to an intake tract (38) for the combustion engine (10). It is hereby possible to cool exhaust gas routed into the intake tract (38) in a particularly simple manner and/or to adjust an amount of exhaust gas routed into the intake tract (38) in a particularly simple manner. The invention also relates to a method of operating a combustion engine (10) of such a motor vehicle, which method also allows to cool exhaust gas routed into the intake tract (38) in a simple manner and/or to adjust an amount of exhaust gas routed into the intake tract (38) in a simple manner.

The invention relates to a motor vehicle in accordance with the preamble of patent claim 1, as well as to a motor vehicle in accordance with the preamble of patent claim 6. The invention is also directed to a method of operating a combustion engine of a type set forth in the preamble of patent claim 10.

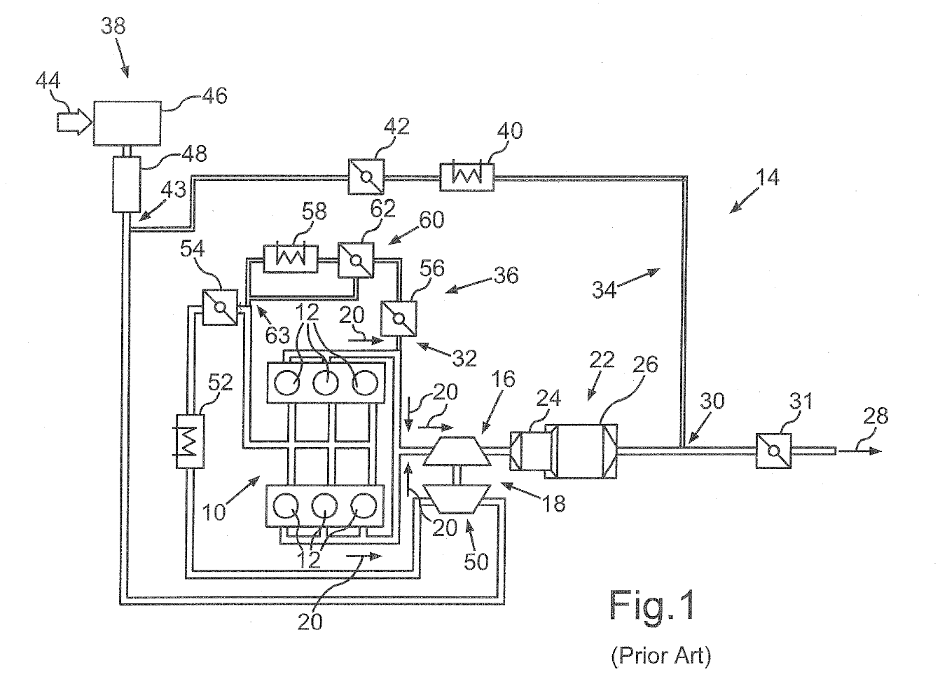

Such motor vehicles and such methods are known from series productions of motor vehicles, wherein in the following a basic principle of a propulsion device for such a motor vehicle will be explained with reference to FIG. 1.

FIG. 1 shows a combustion engine 10 having six cylinders 12. Exhaust gas produced through combustion processes in the cylinders 12 is conducted from the combustion engine 10 to a turbine 16 of an exhaust-gas turbocharger 18 via respective pipes of an exhaust tract 14 for the combustion engine 10. This exhaust gas drives a turbine wheel of the turbine 16. In flow direction of the exhaust gas according to direction arrows 20, an exhaust-gas after-treatment system 22 is arranged downstream of the turbine 16 in the exhaust tract 14 and includes an oxidation catalytic converter 24 and a diesel particle filter 26. The exhaust-gas after-treatment system 22 cleans exhaust gas, before being released to the environment according to direction arrow 28. Arranged downstream of the exhaust-gas after-treatment system 22 is an exhaust-gas flap 31 by which exhaust gas can be backed up in the exhaust tract 14.

Exhaust gas is diverted in flow direction of the exhaust gas upstream and downstream of the turbine 16 at respective withdrawal points 30 and 32 and guided via a respective pipe system 34 and 36 to an intake tract 38. Withdrawal of exhaust gas at the withdrawal point 30 is realized by a so-called low-pressure exhaust-gas recirculation since the exhaust gas has a lower pressure downstream of the turbine 16 than upstream of the turbine 16. Via the pipe system 34, exhaust gas is initially conducted through an exhaust-gas recirculation cooling device 40 which cools the exhaust gas. An exhaust-gas recirculation valve 42 is provided to adjust an amount of exhaust gas diverted at the withdrawal point 30 and being guided to the intake tract 38. Exhaust gas diverted at the withdrawal point 30 is introduced at an induction point 43 into the intake tract 38; This induction point 43 is arranged in flow direction of air drawn in by the combustion engine 10 according to a direction arrow 44 downstream of an air filter 46 and an hot-film air-mass sensor 48 of the intake tract 38; Moreover, the induction point is arranged upstream of a compressor 50 of the exhaust-gas turbocharger 18. The air filter 46 cleans the aspirated air, and the hot-film air-mass sensor 48 measures the mass of aspirated air. The aspirated air is exposed to the diverted exhaust gas, so that an air/exhaust gas mixture is realized which is compressed by the compressor 50 and thereby heated. Arranged downstream of the compressor 50 is a charge-air cooler 52 which cools the air/exhaust gas mixture heated by compression.

Furthermore, a throttle valve 54 is arranged in the intake tract 38. In the event the combustion engine 10 is designed as Otto engine, the throttle valve 54 is adapted to adjust an amount of air aspirated from the combustion engine 10 so as to establish a desired torque of the combustion engine 10. In the event the combustion engine 10 is designed as diesel engine, the throttle valve 54 is adapted to effect a certain pressure gradient to thereby provide a desired, in particular high, amount of recirculating exhaust gas.

Also exhaust gas that has been diverted at the withdrawal point 32 is conducted via a exhaust-gas recirculation valve 56 and an exhaust-gas recirculation cooling device 58 to the intake tract 38. By means of the exhaust-gas recirculation valve 56, the amount of the exhaust gas that has to be diverted at the withdrawal point 32 is adjustable, whereas the exhaust-gas recirculation cooling device 58 is provided to cool the diverted exhaust gas.

The pipe system 36 further includes a bypass device 60 which allows at least a subflow of exhaust gas diverted at the withdrawal point 32 to circumvent the exhaust-gas recirculation cooling device 58 so that this subflow is not cooled by the exhaust-gas recirculation cooling device 58. The bypass device 60 includes a valve device 62 to adjust an amount of exhaust gas which flows through the exhaust-gas recirculation cooling device 58 or bypasses it. Exhaust gas diverted at the withdrawal point 32 is recirculated into the intake tract 38 at an induction point 63 which is arranged in flow direction of the aspirated air downstream of the compressor 50.

The exhaust-gas recirculation valves 42 and 56 as well as the exhaust-gas recirculation coolers 40 and 58 incur high expenses, caused on one hand by high component costs and on the other hand by the highly complex control and regulating system. Guiding exhaust gas to the intake tract 38 is advantageous because to harmful emissions, especially particle and nitric oxide emissions, of the combustion engine can be reduced.

DE 10 2005 052 496 A1 discloses an internal combustion engine in which exhaust gas is guided to an intake tract for the combustion engine and diverted into an exhaust tract of the internal combustion engine. Exhaust gas is hereby being diverted at a withdrawal point which is arranged in flow direction of the exhaust gas upstream of a turbine of an exhaust-gas turbocharger for the internal combustion engine. The diverted exhaust gas can flow through an exhaust-gas recirculation cooler and thereby be cooled. An amount of exhaust gas to be guided to the intake tract is adjustable with a valve device.

DE 10 2006 010 247 A1 discloses an internal combustion engine in which exhaust gas of the internal combustion engine is routed from an exhaust tract to an intake tract, with this exhaust gas being coolable by a cooling device.

It is an object of the present invention to develop a motor vehicle with a combustion engine as well as a method of operating such a combustion engine in such a manner that the combustion engine can be operated at low emission and the costs for the method and for the motor vehicle can be kept low.

This object is attained by a motor vehicle with a combustion engine having the features set forth in patent claim 1 and with the features set forth in patent claim 2 as well as by a method for operating a combustion engine with the features set forth in patent claim 10.

In such a motor vehicle with a combustion engine, from which exhaust gas (via respective pipes of an exhaust tract for the combustion engine) is conducted to a turbine of an exhaust-gas turbocharger, exhaust gas can be diverted in flow direction of the exhaust gas upstream and downstream of the turbine at respective withdrawal points and can be routed via a respective pipe system to an intake tract of the combustion engine. Exhaust gas is introduced into the intake tract, so that air drawn in from the combustion engine and flowing through the intake tract is exposed to the exhaust gas. An exhaust gas recirculation devised in this manner keeps emissions of the combustion engine, especially particle and nitrogen oxide emissions during operation of a combustion engine low. Since two withdrawal points are provided to divert exhaust gas, an especially high amount of exhaust gas can be routed to the intake tract. As a consequence, particularly low harmful emissions, especially particle and nitrogen oxide emissions, are caused by the combustion engine. As a result of the arrangement of the withdrawal points upstream and downstream of the turbine, exhaust gas can be routed to the intake tract by different pressure gradients. Thus, the amount of exhaust gas to be routed to the intake tract is adjustable in a flexible way and can be suited and adapted to different operating points of the combustion engine.

According to the invention, provision is made in accordance with a first aspect of the invention to configure the pipe systems in such a manner that a common, in particular only a single common, cooling device cools exhaust gas diverted upstream and downstream of the turbine. Despite the presence of two withdrawal points for diverting exhaust gas, there is need for only one cooling device to cool the exhaust gas. This leads to a small parts number, little weight, and in particular low costs of an exhaust-gas recirculation device of the motor vehicle.

Compared to conventional exhaust-gas recirculation devices with a cooling device for each withdrawal point, one cooling device is thus eliminated. This is also accompanied by eliminating the need for a possibly additional control. As a result of the elimination, costs can also be lowered, and moreover, additional installation space is created so that package problems, especially in a space-critical zone such as an engine compartment of the motor vehicle, are avoided or solved.

According to a second aspect of the invention, such a motor vehicle is made available in which the pipe systems are configured in such a way that a common, especially only one single common, valve device is provided to adjust an amount of exhaust gas diverted upstream of the turbine and downstream of the turbine. As a result, the motor vehicle has again a small parts number, slight weight and reduced costs. In comparison to conventional exhaust-gas recirculation devices with two withdrawal points, the need for one valve device is eliminated so that component costs are kept low and the control system is less complex. Especially regulation or control of such a valve device for allowing adjustment of the amount of exhaust gas conducted to the intake tract, is complex because the amount of exhaust gas has to be precisely set and suited to different operating points in the mapping of the combustion engine so as to implement operation at low fuel consumption and low emission.

It is particularly advantageous when combining the embodiment of the motor vehicle with the common cooling device with the embodiment of the motor vehicle with the common valve device. Very low costs of the motor vehicle are the result because only one cooling device for cooling and only one valve device for adjustment of the amount of exhaust gas to be routed to the intake tract are provided.

According to an advantageous embodiment of the invention, the motor vehicle includes a bypass device for allowing at least part of the diverted exhaust gas to circumvent the common cooling device. This allows cooling of the diverted exhaust gas by the cooling device as needed so that the temperature of the exhaust gas can be suited to different operating points of the combustion engine. Also, flow losses caused by exhaust gas can be prevented through bypass of the cooling device so that the exhaust gas can be recirculated to the intake tract and introduced into the intake tract in a very efficient manner.

According to a particularly preferred embodiment, a first exhaust-gas recirculation pipe of the respective pipe system, which first exhaust-gas recirculation pipe is fluidly connected with the first withdrawal point and adapted for recirculation of exhaust gas, is united in fluid communication with a second exhaust-gas recirculation pipe of the respective pipe system, which second exhaust-gas recirculation pipe is fluidly connected with the second withdrawal point and adapted for recirculation of exhaust gas to form downstream of the withdrawal points a common exhaust-gas recirculation pipe which is adapted for recirculation of exhaust gas. This means that the pipe systems have at least some portions which are united to a common pipe system. As a result, complexity, parts number and thus costs for the pipe system and thus for the entire motor vehicle can be kept low. Also, the common pipe system requires little installation space.

The first and second exhaust-gas recirculation pipes are united with the common exhaust-gas recirculation pipe preferably by a valve device, especially a 3/2-valve. This valve device involves, for example, a switchable, especially controllable and regulatable valve device. This valve device allows, for example, to feed to the common exhaust-gas recirculation pipe only exhaust gas that has been diverted at the withdrawal point downstream of the turbine. For that purpose, the valve device can be switched to a certain position. It is also possible to switch the valve device to assume a further position in which the common exhaust-gas recirculation pipe receives only exhaust gas that has been diverted at the withdrawal point upstream of the turbine. Another possibility involves supply to the common exhaust-gas recirculation pipe of at least a subflow of exhaust gas that has been diverted at the withdrawal point upstream of the turbine and at least a subflow of exhaust gas that has been diverted at the withdrawal point downstream of the turbine, so that exhaust gas diverted at the respective withdrawal points is mixed in the common exhaust-gas recirculation pipe. In this way, another degree of freedom is created to adjust the temperature and the amount of exhaust gas to be routed to the intake tract, as well as a desired pressure gradient for guiding the exhaust gas to the intake tract.

To provide an especially flexible adjustment of the amount and/or temperature of exhaust gas to be routed to the intake tract and thus to suit the amount and/or temperature to different operating conditions of the combustion engine in a very flexible manner, the following measure is taken: There are two induction points where exhaust gas can be introduced into the intake tract upstream and downstream of the turbine. A first one of those induction points is arranged in flow direction of air, aspirated by the combustion engine and flowing through the intake tract, upstream of a compressor of the exhaust-gas turbocharger, arranged in the intake tract and operated by the turbine. The second one of these induction points is arranged downstream of the compressor.

The compressor compresses air aspirated by the combustion engine so as to provide a higher pressure level downstream of the compressor than upstream of the compressor. To expose compressed or uncompressed air at the respective induction point to the recirculated exhaust gas, it is necessary that the exhaust gas to be introduced into the intake tract at the respective induction point, has a higher pressure level than air at this induction point. According to a respective pressure difference between the exhaust gas to be introduced and the compressed or uncompressed air, air is exposed to a certain amount of exhaust gas. In other words, the amount of exhaust gas mixed to air depends on the pressure level of air and the pressure level of exhaust gas. This embodiment provides therefore great flexibility to expose the compressed and/or uncompressed air to exhaust gas, and consequently to realize a very efficient and low-emission operation of the combustion engine.

Furthermore, this pressure gradient can be influenced and adjusted, for example, by an exhaust flap in the intake tract and/or a throttle valve in the intake tract. The exhaust flap is arranged, for example, downstream of the turbine and is provided to narrow a flow cross section of a respective pipe casing or to clear it so that exhaust gas backs up in the pipe casing and a greater exhaust counterpressure is adjusted, causing a high pressure gradient. This creates a further possibility to conduct an especially high amount of exhaust gas to the intake tract.

Accordingly, also the throttle valve in the intake tract, arranged for example in flow direction of the air downstream of the compressor, can attain back-up of more or less aspirated air by narrowing or clearing a flow cross section of a respective pipe casing in order to establish a higher or lower pressure gradient for adjustment of the amount of the exhaust gas to be recirculated. For that purpose, nearly any amounts of exhaust gas and any exhaust-gas recirculation rates in at least nearly all load ranges and in the at least nearly entire mapping of the combustion engine can be adjusted, promoting low-emission and efficient operation of the combustion engine.

To save weight, costs, and installation space, it can advantageously be provided to branch the common exhaust recirculation pipe, adapted for recirculation of exhaust gas, upstream of an induction point into a first exhaust-gas recirculation pipe, which is fluidly connected to the first induction point and adapted for recirculation of exhaust gas, and into a second exhaust-gas recirculation pipe, which is fluidly connected to the second induction point and adapted for recirculation of exhaust gas. Exhaust gas to be recirculated thus flows first through the common exhaust-gas recirculation pipe and is then split by the branching common exhaust-gas recirculation pipe for introduction into the intake tract at the respective induction point.

According to a further advantageous embodiment, the common exhaust-gas recirculation pipe adapted for recirculation of exhaust gas branches via a valve device, in particular a 3/2 valve, into the first and the second exhaust-gas recirculation pipes which are connected to the induction points, respectively. Through the presence of such a valve device, which in particular is switchable and controllable and regulatable, another possibility is created to assign the exhaust gas routed to the intake tract, solely to the first induction point or solely to the second induction point. It is also possible to assign a certain part of exhaust gas to be recirculated to the first induction point and a further part of the exhaust gas to be recirculated to the second induction site. This provides another degree of freedom to adjust the amount of exhaust gas to which aspirated air is to be exposed and thus the exhaust gas recirculation rate to a desired value and thereby operate the combustion engine efficiently and at low consumption.

The invention also relates to a method of operating a combustion engine, which involves exhaust gas of the combustion engine to be conducted to a turbine of an exhaust-gas turbocharger, wherein exhaust gas is diverted in flow direction of the exhaust gas upstream and downstream of the turbine at respective withdrawal points and routed to an intake tract for the combustion engine via a respective pipe system.

According to the invention, exhaust gas diverted upstream and downstream of the turbine is cooled by a common cooling device and/or an amount of exhaust gas diverted upstream and downstream of the turbine is adjusted by a common valve device. The method according to the invention thus involves, despite the presence of two withdrawal points, only one cooling device and/or only one valve device for respective cooling and adjustment of the amount of exhaust gas to be routed to the intake tract. This minimizes the parts number and the weight of a motor vehicle operated by a combustion engine.

Also execution of the control and regulation of the method is not elaborate because only one valve device is to be controlled or regulated. The method does not require to control two valve devices simultaneously and to synchronize them. This slight complexity for control leads to low costs to execute the method. Still, the method allows a very flexible approach to suit the amount and the temperature of exhaust gas to be recirculated to different operating points in the mapping of the combustion engine and thus to realize an efficient and low-emission operation of the combustion engine. Advantageous configurations of the motor vehicles according to the invention are to be considered as advantageous configurations of the method according to the invention, and vice versa.

Further advantages, features and details of the invention are set forth in the following description of a preferred exemplary embodiment and in the drawings. The features and combination of features as mentioned above in the description as well as individual features and combination of features described hereinafter in the figure description and/or figures are not only applicable in the respectively set forth combination but also in other combinations or taken alone without departing the scope of the invention.

The drawings shows in:

FIG. 1 a basic illustration of a prior art propulsion device with a combustion engine for a motor vehicle, with exhaust gas from the combustion engine being conducted to a turbine of an exhaust-gas turbocharger, wherein exhaust gas is diverted in flow direction of the exhaust gas upstream and downstream of the turbine and guided to an intake tract for the combustion engine; and

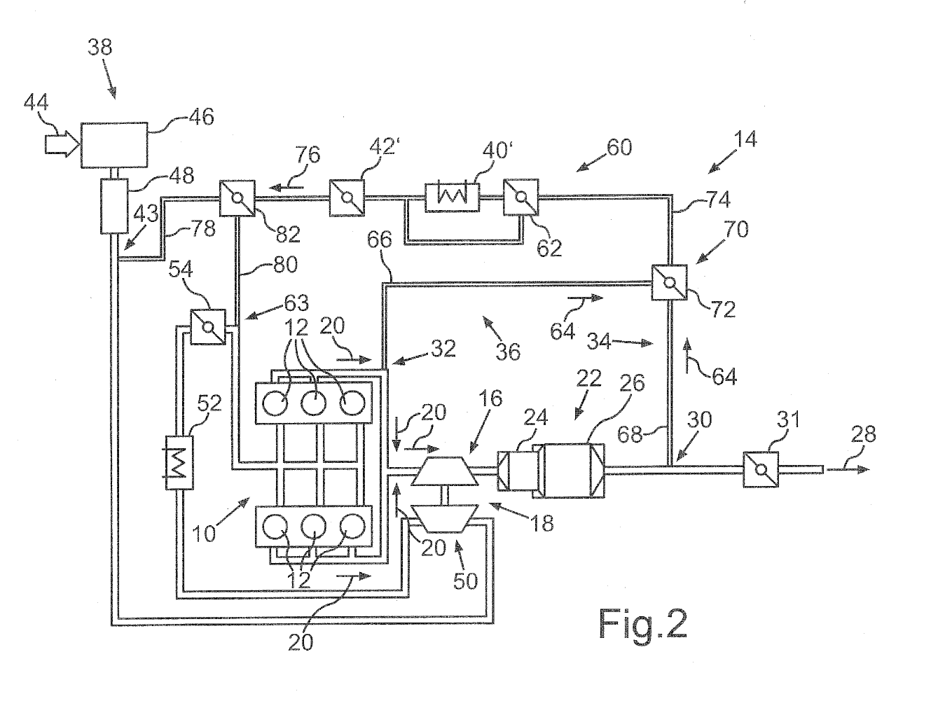

FIG. 2 a basic illustration corresponding to FIG. 1, of another embodiment of a propulsion device with a combustion engine for a motor vehicle, according to FIG. 1, having only one exhaust-gas recirculation valve and one exhaust-gas recirculation cooling device to cool the exhaust gas to be conducted to the intake tract and to adjust an amount of this exhaust gas, respectively.

In the Figures, same reference signs designate same elements.

FIG. 2 shows the combustion engine 10 for a motor vehicle, with exhaust gas from the combustion engine 10 being conducted via respective pipes of the exhaust tract 14 to the turbine 16 of the exhaust-gas turbocharger 18. The turbine 16 is configured as turbine with variable turbine geometry and is operated by exhaust gas conducted thereto. The turbine 16 drives the compressor 50 of the exhaust-gas turbocharger 18, which compressor is arranged in the intake tract 38 and compresses air aspirated by the combustion engine.

In flow direction of the exhaust gas according to direction arrows 20, exhaust gas is diverted upstream of the turbine 16 at the withdrawal point 32 and downstream of the turbine 16 as well as downstream of the exhaust-gas after-treatment device 22 at the withdrawal point 30, and routed initially via the pipe systems 34 and 36 to the intake tract 38. In contrast to FIG. 1, a first exhaust-gas recirculation pipe 66 is united with a second exhaust-gas recirculation pipe 68 in flow direction of the respective exhaust gas being recirculated according to direction arrows 62 upstream of the withdrawal points 30 and 32 via a 3/2 valve 72 at a coupling point 70. The first exhaust-gas recirculation pipe 66 is hereby connected to the first withdrawal point 32, whereas the second exhaust-gas recirculation pipe 68 is connected to the second withdrawal point 30.

The switchable and optionally electrically actuatable 3/2 valve 72 enables exhaust gas to be routed to the exhaust-gas recirculation pipe 74 solely via the exhaust-gas recirculation pipe 68 or solely via the exhaust-gas recirculation pipe 66. It is, for example, also possible for the exhaust-gas recirculation pipe 74 to receive a certain amount of exhaust gas from the exhaust-gas recirculation pipe 68 and a certain amount from the exhaust-gas recirculation pipe 66.

By uniting the exhaust-gas recirculation pipes 66 and 68, it becomes possible to use only one exhaust-gas recirculation cooling device 40′ for cooling of exhaust gas to be routed to the intake tract 38 and to use only one exhaust-gas recirculation valve 42′ for adjustment of an amount of exhaust gas to be recirculated. There is no need for the presence of two exhaust gas recirculation cooling devices 40 and 58 and no need for the presence of two exhaust gas recirculation valves 42 and 56 so that the demand for installation space and complexity of control and thus costs for recirculation of exhaust gas from the exhaust tract 14 to the intake tract 38 can be kept very low.

The common exhaust-gas recirculation pipe 74 branches in flow direction of exhaust gas to be recirculated according to a direction arrow 76 upstream of the induction points 42 and 63 into a first exhaust-gas recirculation pipe 78, connected with the first induction point 43 and adapted for recirculation of the exhaust gas, and a second exhaust-gas recirculation pipe 80, fluidly connected with the second induction point 63 and adapted for recirculation of exhaust gas. The exhaust-gas recirculation pipe 74 branches off via a switchable and optionally electrically actuatable 3/2 valve 82. The 3/2 valve 82 enables in analogy to the 3/2 valve 72 to conduct exhaust gas flowing through the exhaust-gas recirculation pipe 74 either exclusively to the exhaust-gas recirculation pipe 78 or exclusively to the exhaust-gas recirculation pipe 80. It is also possible to conduct to the exhaust-gas recirculation pipe 78 at least a subflow of exhaust gas flowing through the exhaust-gas recirculation pipe 74 and to conduct to the exhaust-gas recirculation pipe 80 a subflow of exhaust gas flowing through the exhaust-gas recirculation pipe 74. This provides high flexibility, despite the common exhaust-gas recirculation pipe 74, to feed exhaust gas to be recirculated adequately for the need at hand and at least in part to the intake tract 38 at the induction point 43 and/or at the induction point 63. As a result, the amount and temperature of exhaust gas to which the aspirated air should be exposed can be adjusted adequately for the need at hand and suited to at least nearly all load and rotation speed ranges of the combustion engine 10 at least nearly in all operating points.

This flexible adjustment of exhaust-gas recirculation rates is further enhanced by optionally arranging an exhaust-gas flap 31 at the exhaust tract 14 and arranging a throttle valve 54 in the intake tract 38, to allow setting of a pressure gradient between exhaust gas to be recirculated and aspirated air by more or less backing up exhaust gas and/or air in respective pipe casings.

What is claimed is:

1-10. (canceled)

11. A motor vehicle, comprising:
a combustion engine having an intake tract;
an exhaust-gas turbocharger having a turbine receiving exhaust gas from the combustion engine;
a first pipe system routing exhaust gas diverted at a first withdrawal point upstream of the turbine to the intact tract;
a second pipe system routing exhaust gas diverted at a second withdrawal point downstream of the turbine to the intact tract; and
a common cooling device configured to cool exhaust gas diverted upstream and downstream of the turbine.

12. The motor vehicle of claim 11, further comprising a bypass device to enable a subflow of diverted exhaust gas to circumvent the common cooling device.

13. The motor vehicle of claim 11, wherein the first pipe system includes a first exhaust-gas recirculation pipe which is fluidly connected to the first withdrawal point and adapted for recirculation of exhaust gas, a second exhaust-gas recirculation pipe which is fluidly connected to the second withdrawal point and adapted for recirculation of exhaust gas, and a common exhaust-gas recirculation pipe uniting the first and second exhaust-gas recirculation pipes downstream of the first and second withdrawal points for recirculation of the exhaust gas.

14. The motor vehicle of claim 13, further comprising a valve device, said first and second exhaust-gas recirculation pipes being connected to the common exhaust-gas recirculation pipe via the valve device.

15. The motor vehicle of claim 14, wherein the valve device is a 3/2 valve.

16. The motor vehicle of claim 11, wherein the exhaust-gas turbocharger includes a compressor arranged in the intake tract, wherein exhaust gas diverted upstream and downstream of the turbine is recirculated in flow direction of air aspirated by the combustion engine at least in one of two ways, a first way at a first introduction point upstream of the compressor, a second way at a second introduction point downstream of the compressor.

17. The motor vehicle of claim 16, wherein the first pipe system includes a first exhaust-gas recirculation pipe which is fluidly connected to the first withdrawal point and adapted for recirculation of exhaust gas, a second exhaust-gas recirculation pipe which is fluidly connected to the second withdrawal point and adapted for recirculation of exhaust gas, and a common exhaust-gas recirculation pipe uniting the first and second exhaust-gas recirculation pipes downstream of the first and second withdrawal points for recirculation of the exhaust gas, said common exhaust-gas recirculation pipe branches upstream of the first and second introduction points into a third exhaust-gas recirculation pipe which is fluidly connected with the first introduction point and adapted for recirculation of exhaust gas, and to a fourth exhaust-gas recirculation pipe which is fluidly connected with the second introduction point and adapted for recirculation of exhaust gas.

18. The motor vehicle of claim 17, further comprising a valve device, said third and fourth exhaust-gas recirculation pipes being connected to the common exhaust-gas recirculation pipe via the valve device.

19. The motor vehicle of claim 18, wherein the valve device is a 3/2 valve.

20. A motor vehicle, comprising:
a combustion engine having an intake tract;
an exhaust-gas turbocharger having a turbine receiving exhaust gas from the combustion engine;
a first pipe system routing exhaust gas diverted at a first withdrawal point upstream of the turbine to the intact tract;
a second pipe system routing exhaust gas diverted at a second withdrawal point downstream of the turbine to the intact tract; and
a common valve device configured to adjust an amount of exhaust gas diverted upstream and downstream of the turbine.

21. The motor vehicle of claim 20, further comprising a common cooling device configured to cool the exhaust gas diverted upstream and downstream of the turbine.

22. The motor vehicle of claim 21, further comprising a bypass device to enable a subflow of diverted exhaust gas to circumvent the common cooling device.

23. The motor vehicle of claim 20, wherein the first pipe system includes a first exhaust-gas recirculation pipe which is fluidly connected to the first withdrawal point and adapted for recirculation of exhaust gas, a second exhaust-gas recirculation pipe which is fluidly connected to the second withdrawal point and adapted for recirculation of exhaust gas, and a common exhaust-gas recirculation pipe uniting the first and second exhaust-gas recirculation pipes downstream of the first and second withdrawal points for recirculation of the exhaust gas.

24. The motor vehicle of claim 23, further comprising a valve device, said first and second exhaust-gas recirculation pipes being connected to the common exhaust-gas recirculation pipe via the valve device.

25. The motor vehicle of claim 24, wherein the valve device is a 3/2 valve.

26. The motor vehicle of claim 20, wherein the exhaust-gas turbocharger includes a compressor arranged in the intake tract, wherein exhaust gas diverted upstream and downstream of the turbine is recirculated in flow direction of air aspirated by the combustion engine at least in one of two ways, a first way at a first introduction point upstream of the compressor, a second way at a second introduction point downstream of the compressor.

27. The motor vehicle of claim 26, wherein the first pipe system includes a first exhaust-gas recirculation pipe which is fluidly connected to the first withdrawal point and adapted for recirculation of exhaust gas, a second exhaust-gas recirculation pipe which is fluidly connected to the second withdrawal point and adapted for recirculation of exhaust gas, and a common exhaust-gas recirculation pipe uniting the first and second exhaust-gas recirculation pipes downstream of the first and second withdrawal points for recirculation of the exhaust gas, said common exhaust-gas recirculation pipe branches upstream of the first and second introduction points into a third exhaust-gas recirculation pipe which is fluidly connected with the first introduction point and adapted for recirculation of exhaust gas, and to a fourth exhaust-gas recirculation pipe which is fluidly connected with the second introduction point and adapted for recirculation of exhaust gas.

28. The motor vehicle of claim 27, further comprising a valve device, said third and fourth exhaust-gas recirculation pipes being connected to the common exhaust-gas recirculation pipe via the valve device.

29. The motor vehicle of claim 28, wherein the valve device is a 3/2 valve.

30. A method of operation of a combustion engine, comprising the steps of:
conducting exhaust gas from the combustion engine to a turbine of an exhaust-gas turbocharger;
diverting a first subflow of exhaust gas in flow direction of the exhaust gas upstream of the turbine;
diverting a second subflow of exhaust gas in the flow direction of the exhaust gas downstream of the turbine;
guiding the first and second subflows via respective pipe systems to an intake tract for the combustion engine; and
treating the first and second subflows in at least one of two ways, a first way in which the first and second subflows are cooled by a common cooling device, a second way in which an amount of the first and second subflows is adjusted by a common valve device.
